(19) United States
(12) Patent Application Publication
(10) Pub. No.: US 2022/0389040 A1
(43) Pub. Date: Dec. 8, 2022

(54) AN INDUSTRIAL PROCESS FOR RESOLUTION OF CHLOCYPHOS

(71) Applicant: Hikal Limited, Maharashtra (IN)

(72) Inventors: Rakesh Ramesh GANORKAR, Maharashtra (IN); Sudhir NAMBIAR, Maharashtra (IN); Narayan Subhash CHAKOR, Maharashtra (IN); H.D. GURUPADASWAMY, Maharashtra (IN); Shamrao Bapurao SHELAR, Maharashtra (IN)

(73) Assignee: Hikal Limited, Maharashtra (IN)

(21) Appl. No.: 17/769,718

(22) PCT Filed: Oct. 13, 2020
(86) PCT No.: PCT/IB2020/059589

§ 371 Date: Apr. 15, 2022

(30) Foreign Application Priority Data
Oct. 16, 2019 (IN) 201921041836

(51) Int. Cl. C07F 9/6574; C07B 57/00

(52) U.S. Cl. CPC C07F 9/65742; C07B 57/00; C07B 2200/07

(57) ABSTRACT

The present invention relates to a process for resolution of Chlocyphos of Formula (I) to obtain corresponding (S)- or (R)-isomers. The present invention further relates to a process of obtaining (S)-Chlocyphos using (R)-(+)-α-methylbenzylamine and (R)-Chlocyphos using (S)-α-methylbenzylamine. The said resolution process provides the corresponding isomer with chiral purity more than 98%.

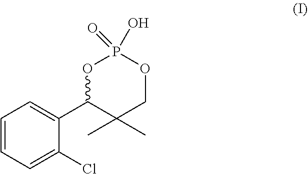 [SMILES: CC1(C)COP(=O)(O)OC1c1ccccc1Cl]

### RELATED APPLICATION

This application claims the benefit to Indian Provisional Application No. IN201921041836, filed on Oct. 16, 2019, the contents of which are incorporated by reference herein.

### FIELD OF THE INVENTION

The present invention relates to a process for resolution of Chlocyphos of formula (I) to obtain corresponding (S)- or (R)-isomer. The present invention further relates to a process of obtaining (S)-Chlocyphos using (R)-(+)-α-methylbenzylamine and (R)-Chlocyphos using (S)-(−)-α-methylbenzylamine. The said resolution process provides the corresponding isomer with chiral purity more than 98%.

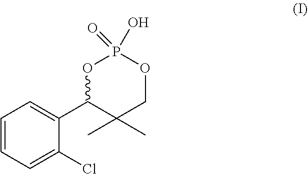 [SMILES: CC1(C)COP(=O)(O)OC1c1ccccc1Cl]

### BACKGROUND OF THE INVENTION

Chlocyphos of formula (I) having CAS No. 98634-28-7 is acyclic phosphoric acid derivative, an optically active isomer of chlocyphos is an effective resolving agent to separate optically active isomers of various intermediates and pharmaceutical agents. The optically active isomers of chlocyphos is used in resolving various compounds such as Bedaquiline, D-serine, Metoprolol, Rotigotine, Valine etc.

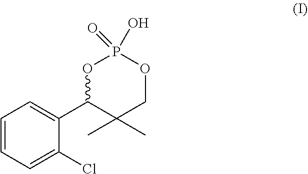 [SMILES: CC1(C)COP(=O)(O)OC1c1ccccc1Cl]

Various resolving agents are disclosed for the resolution of racemic chlocyphos to its active (R)- or(S)-isomer. One of the resolving agent (−)-(p-hydroxyphenylglycine) was known to separate chlocyphos to get corresponding (S)-Chlocyphos (JOC, 1985, 50(23), 4508-14), however it is not economically viable reagent in industrial scale.

The U.S. Pat. No. 6,800,778B1 discloses various cyclic phosphoric acid derivatives and they were separated by optical resolution using different chiral amines. It further discloses the difficulty of finding which (optically) active amino compound is suitable for the resolution of a particular cyclic phosphoric acid derivative because optical amines vary based on specific cyclic phosphoric acid derivative. Though there are plenty of resolving agents available in the art, only few may practically useful. Therefore, it is necessary to screen several resolving agents to find a good combination of racemate and resolving agent. Most of the phosphoric acids including chlocyphos were separated using (−)-ephedrine,(−)-(p-hydroxyphenyl) glycine, (+)-2-amino-1-phenyl-1,3-propanediol, however, these reagents are not commercially viable.

First time, the present invention provides a resolution of chlocyphos using optically active α-methylbenzylamine to obtain corresponding isomers. It enables resolution of chlocyphos using a cost effective resolving agent by diastereomeric salt formation. The present invention also includes the recovery and further racemization of undesired isomer.

### SUMMARY OF THE INVENTION

The main object of the present invention is to provide a resolution process of a Chlocyphos of formula (I) using suitable resolving agent.

The other object of the present invention is to provide a resolution process of a chlocyphos of formula (I) using suitable resolving agent to obtain corresponding isomers with chiral purity greater than 98%.

Another objective of the present invention is to provide a process for the resolution of a chlocyphos of formula (I), which is simple and commercially viable.

In one aspect, the present invention provides a process for resolution of Chlocyphos of formula (I) to obtain an optically active isomers, which comprises the steps:

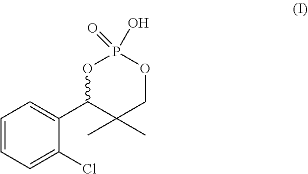 [SMILES: CC1(C)COP(=O)(O)OC1c1ccccc1Cl]

a) treating a Chlocyphos of formula (I) with an optically active α-methylbenzylamine as resolving agent in a solvent to obtain corresponding diastereomeric salt;
b) treating the diastereomeric salt with an acid in a solvent to obtain an optically active desired enantiomer;
c) optionally recovering the undesired isomer.

In another aspect, the present invention provides a process for resolution of Chlocyphos of formula (I) to get (S)-isomer, which comprises the steps:
a) treating a Chlocyphos of formula (I) with (R)-(+)-α-methylbenzylamine in a solvent to obtain diastereomeric salt;
b) treating the diastereomeric salt with an acid in a solvent to obtain a (S)-Chlocyphos of formula (Ib);

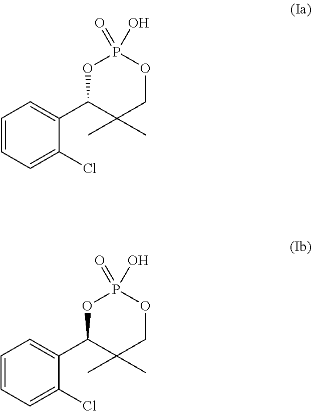

c) optionally recovering the undesired (R)-isomer of Formula (Ia).

In another aspect, the present invention provides a process for resolution of Chlocyphos of formula (I) to obtain corresponding (R)-isomer, which comprises the steps:
a) treating a Chlocyphos of formula (I) with (S)-(−)-α-methylbenzylamine in a solvent to obtain diastereomeric salt;
b) treating the diastereomeric salt with an acid in a solvent to obtain a (R)-Chlocyphos of formula (Ia);

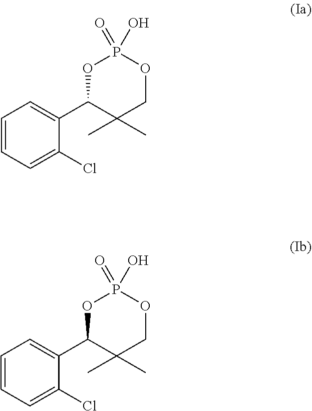

c) optionally recovering the undesired (S)-isomer of formula (Ib).

In yet another aspect, the present invention provides a process for recovery of undesired isomer of Chlocyphos comprises the steps:

a) treating any one of diastereomeric salt with an acid;

b) filtering the reaction mixture to obtain solid;

c) washing with water and drying the solid to obtain corresponding (R)-isomer or (S)-isomer.

### DETAILED DESCRIPTION OF THE INVENTION

The present invention now is described in more detail hereinafter. The invention is embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly indicates otherwise.

The instant invention relates to a process for resolution of Chlocyphos of formula (I) to obtain corresponding (S)- or (R)-isomers. The (R)-chlocyphos of formula (la) and (S)-chlocyphos of formula (Ib) are respectively known as (R)-(+)-4-(2-chlorophenyl)-5,5-dimethyl-2-hydroxy-1,3,2-dioxaphosphinane 2-oxide and (S)-(−)-4-(2-chlorophenyl)-5,5-dimethyl-2-hydroxy-1,3,2-dioxaphosphinane 2-oxide.

The present invention enables resolution of chlocyphos of formula (I) by diastereomeric salt formation with (R)-(+)-α-methylbenzylamine or (S)-(−)-α-methylbenzylamine as resolving agent to obtain salt of corresponding (S)- or (R)-isomers respectively; further treating the diastereomeric salt of corresponding (S)- or (R)-isomers with an acid to get pure enantiomer (S)-chlocyphos or (R)-chlocyphos and optionally recovering undesired enantiomer separately. The said resolution process provides the corresponding isomer with chiral purity more than 98%.

The above process is illustrated in the following general synthetic scheme 1:

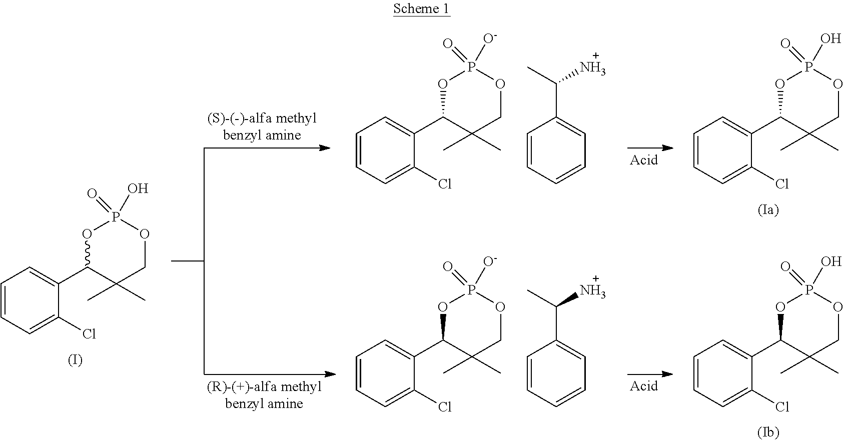

The term solvent used herein, refers to the single solvent or mixture of solvents.

In another embodiment of the present invention, wherein a solvent used in step (a) is selected from a group consisting of water, alcoholic solvents such as methanol, ethanol, isopropanol; acetate solvents such as ethyl acetate, isopropyl acetate and the like.

In another embodiment of the present invention, wherein the said acid used in step (b) is selected from a group consisting of hydrochloric acid, hydrobromic acid, sulfuric acid, phosphoric acid and the like.

In another embodiment of the present invention, wherein a solvent used in step (b) is selected from a group consisting of water, alcoholic solvents such as methanol, ethanol, isopropanol; acetate solvents such as ethyl acetate, isopropyl acetate and the like.

The instant invention produces (S)-Chlocyphos (Ib) using (R)-(+)-α-methylbenzylamine which is readily available at low price.

In another embodiment of the present invention, the reaction temperature of: step (a) is 20° C. to 85° C.; step (b) is 20° C. to 85° C.; and step (c) is 20° C. to 40° C. In another embodiment of the present invention, wherein the reaction time of: step (a) is 1-10 hours; step (b) is 2-6 hours; and step (c) is 1-3 hours.

In another embodiment of the present invention, wherein the optically active enantiomer of formula (Ia) or (Ib) is obtained with chemical purity greater than 98% and chiral purity greater than 98%.

In another embodiment of the present invention, wherein the racemic chlocyphos of formula (I) is prepared by process illustrated in synthetic scheme 2.

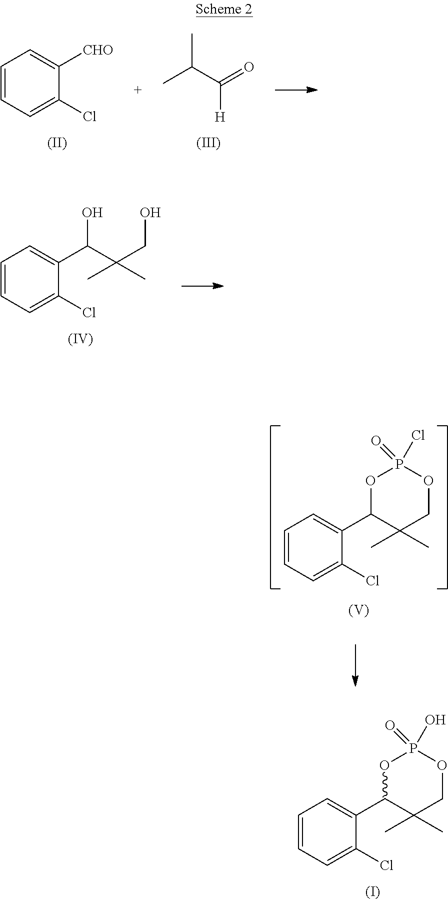

In another embodiment of the present invention, wherein the process illustrated in synthetic scheme 2 for preparation of racemic chlocyphos of formula (I) comprises: (i) reacting 2-chloro benzaldehyde of formula (II) and isobutyraldehyde of formula (III) in presence of base in a solvent to obtain compound of formula (IV);

(ii) treating compound of formula (IV) with chlorinating agent in a solvent to obtain compound of formula (V);

(iii) treating compound of formula (V) with a base in solvent to obtain racemic chlocyphos of formula (I).

In another embodiment of the present invention, wherein all the crude compound is used as such or purified by distillation or crystallization or by different techniques well understood by those skilled in the art.

The preparation of the starting materials and reagents used in the present invention are well known in prior art.

The invention is further illustrated by the following examples, which should not be construed to limit the scope of the invention in anyway.

### EXPERIMENTAL

### Example 1: Resolution of Chlocyphos using (S)-(−)-α-methylbenzylamine to Obtain (R)-chlocyphos (Ia)

The ethanol (42 mL, 6V) and racemic chlocyphos (7 g, 0.0253 mol, 1 eq) were charged in reactor and stirred for 15-30 min at rt. The S-(−)-α-methyl benzyl amine (3.0 g, 0.0254 mol, 1 eq) was added and stirred for 15-30 min at rt. The reaction mass was heated to reflux and maintained for 2 h. The reaction mass was cooled to 20° C. to 30° C. and stirred for 8 h. The slurry was filtered and washed with ethanol. The wet cake and ethanol (21 mL) were taken in reactor and heated to reflux for 2 h. The reaction mass was cooled to 20° C. to 30° C. and stirred for 2 h. The slurry was filtered and washed with ethanol. The filtrate was separately treated to recover undesired enantiomer. The wet cake and diluted hydrochloric acid (HCl) (21 mL) were stirred at rt for 3-6 h. The slurry was filtered and washed with water and dried to yield the product as white solid. (yield: 2.38 g (34% yield), [α]₅₇₈+49°; purity by HPLC 99.62% and chiral purity 97.30%.

¹H-NMR (CDCl₃, 400 MHz): 7.38-7.50 (m, 4H), 5.66 (d, 1H, J=1.6 Hz), 4.21 (d, 1H, J=11.2 Hz), 3.87-3.96 (m, 1H), 1.00 (s, 3H), 0.73 (s, 3H);

### Example 2: Resolution of Chlocyphos using (R)-(+)-α-methylbenzylamineto Obtain (S)-chlocyphos (Ib)

The ethanol (420 L, 6V) and racemic chlocyphos (70 Kg, 253 mol, 1 eq) were charged in a reactor and stirred for 15-30 min at rt. The R-(+)-α-methyl benzyl amine (30.8 Kg, 254.2 mol, 1 eq) was added and stirred for 15-30 min at rt. The reaction mass was heated to reflux and maintained for 1 to 5 h. The reaction mass was cooled and stirred for 8 h. The slurry was filtered and washed with ethanol. The wet cake and ethanol (210 L) were taken in reactor and heated to reflux for 2 h. The reaction mass was cooled and stirred for 2 h. The slurry was filtered and washed with ethanol. The filtrate was separately treated to recover another enantiomer. The wet cake and dilute hydrochloric acid (HCl) (210 L) were stirred at rt for 3-6 h. The slurry was filtered and washed with water and dried to yield the product as white solid. (yield: 23.8 Kg (34% yield), [α]₅₇₈−49°; purity by HPLC 99.97% and chiral purity 98.66%.

¹H-NMR (CDCl₃, 400 MHz): 7.38-7.50 (m, 4H), 5.66 (d, 1H, J=2 Hz), 4.21 (d, 1H, J=11.2 Hz), 3.87-3.96 (m, 1H), 1.00 (s, 3H), 0.73 (s, 3H);

¹³C-NMR (DMSO-d6, 400 MHz): 134.08, 133.98, 131.98, 130.15, 130.07, 129.33, 127.04, 81.23, 81.18, 77.20, 77.14, 36.84, 36.81, 20.01, 17.35.

General Process for Recovery of (S)-Chlocyphos or (R)-Chlocyphos

The filtrate (obtained from example 1 or 2) was distilled-out up to minimum volume. To this, 20% HCl was added and the reaction mixture was stirred for 3 h at 20° C. to 40° C. to get the solid. The solid was filtered, washed with water and dried to obtain the corresponding isomer.

### Example 3: Process for Recovery of (R)-Chlocyphos (Ia)

The filtrate (obtained from example 1 or 2) was distilled out up to minimum volume. To this, 20% HCl was added (5 V) and the reaction mixture was stirred for 3 h at 20° C. to 40° C. to get the solid. The solid was filtered, washed with water and dried at 55° C. to 65° C. to obtain (R)-Chlocyphos as a white solid (yield: 32%).

1. A resolution process of Chlocyphos of formula (I) to obtain active isomers, which comprises the steps of: 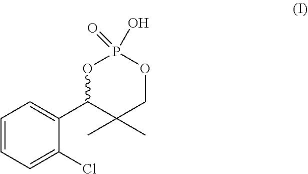 [SMILES: CC1(C)COP(=O)(O)OC1c1ccccc1Cl]
(a) treating a Chlocyphos of formula (I) with an optically active α-methylbenzylamine resolving agent in a solvent to obtain diastereomeric salt;
(b) treating the diastereomeric salt with an acid in a solvent to obtain an optically active desired enantiomer of formula (Ia) or (Ib); 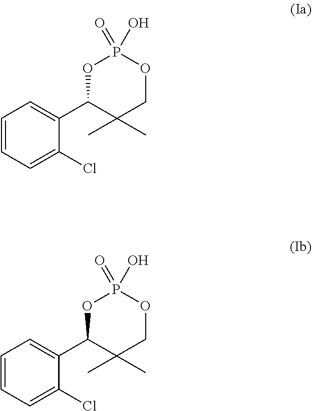
(c) optionally recovering the undesired isomer.

2. The process as claimed in claim 1, wherein the optically active α-methylbenzylamine used in step (a) is selected from S-(−)-α-methyl benzyl amine and R-(+)-α-methyl benzyl amine.

3. The process as claimed in claim 1, wherein obtaining an active isomer of formula (Ib), comprises the steps of:
(a) treating a Chlocyphos of formula (I) with (R)-(+)-α-methylbenzylamine in a solvent to obtain diastereomeric salt;
(b) treating the diastereomeric salt with an acid in a solvent to obtain a (S)-Chlocyphos of formula (Ib);
(c) optionally recovering undesired (R)-isomer of Formula (Ia).

4. The process as claimed in claim 1 wherein obtaining an active isomer of formula (Ia), which comprises the steps of:
(a) treating a Chlocyphos of formula (I) with (S)-(−)-α-methylbenzylamine in a solvent to obtain diastereomeric salt;
(b) treating the diastereomeric salt with acid in a solvent to obtain a (R)-Chlocyphos of formula (Ia);
(c) optionally recovering undesired (S)-isomer of formula (Ib).

5. The process as claimed in claim 1, wherein the solvent used in step (a) and step (b) is selected from a group consisting of water, alcoholic solvents such as methanol, ethanol, isopropanol; acetate solvent such as ethyl acetate and isopropyl acetate.

6. The process as claimed in claim 1, wherein recovering the undesired isomer comprises the steps of:
(a) treating diastereomeric salt with an acid;
(b) filtering the reaction mixture to obtain solid;
(c) washing with water and drying the solid to obtain (R)-isomer (Ia) or (S)-isomer (Ib).

7. The process as claimed in claim 1, wherein the acid used is selected from the group consisting of hydrochloric acid, hydrobromic acid, sulfuric acid and phosphoric acid.
